(19) United States
(12) Patent Application Publication
(10) Pub. No.: US 2006/0248649 A1
(43) Pub. Date: Nov. 9, 2006

(54) Combination Wheelchair/Gurney

(76) Inventor: Rainer Kuenzel, Hunt, TX (US)

Correspondence Address: TIM COOK, P.O. BOX 10107, LIBERTY, TX, 77575, US

(21) Appl. No.: 10/907,902

(22) Filed: Apr. 20, 2005

(51) Int. Cl. A61G 7/10; A61G 7/015

(52) U.S. Cl. 5/618; 5/81.1 R; 5/86.1

(57) ABSTRACT

A bi-directional gurney/wheelchair is provided. The device comprises five panels, including a center panel, a pair of intermediate panels, and a pair of end panels. The intermediate panels are interlocked so that they always remain parallel to one another. The end panels operate independently of one another. The device further includes a power means to raise and lower the center panel, which in turn raises and lowers the other panels. A pair of U-shaped support bars mechanically support a pair of parallel structural beams so that the device can be positioned over a standard toilet from either direction. Further, means is provided to mechanically assist a patient onto the gurney/wheelchair.

### FIELD OF THE INVENTION

The present invention relates generally to the filed of hospital equipment and, more particularly, to a gurney or hospital bed which flexibly converts to a wheelchair with the patient's head at either end of the device.

### BACKGROUND OF THE INVENTION

Various apparatus known in the art are commonly used by healthcare providers to transport patients from one place to another. For one example, wheelchairs, whether battery powered or hand-powered, are commonly used to move patients in all kinds of medical care or retirement environments while the patient sits in the wheelchair in a vertical position. For another example, gurneys are used in hospitals, nursing homes, and other places to move patients from one place to another while the patient remains in a substantially horizontal position. Often, health care providers wish to move a patient from a hospital bed to a gurney or to a wheelchair or from a wheelchair into a bed or gurney.

Unfortunately, injuries often occur to healthcare providers and to patients when patients are moved between such apparatus. When a patient is transferred from a bed to a wheelchair, the patient must be lifted to a sitting position, rotated so that his feet are over the side of the bed, and then lifted from the bed to the chair. This evolution often requires three people to safely carry out the transfer, e.g. two to lift the patient off the bed, and one to rotate the patient and gently guide him into the chair. Similarly, if the patient is to be transferred from a bed to a gurney, two and sometimes three people are required for a safe transfer; two to lift the patient and one to stabilize the gurney.

All too often, however, fewer than three people are available to move a patient from one apparatus to another. In fact, nurses and orderlies are often called upon to make such a transfer alone. This can easily result in back strain for the nurse or orderly, and despite the nurse's best efforts, may result in injury to the patient.

A solution to this problem was proposed by Blevins et al. in U.S. Pat. No. 5,996,150. In Blevins et al., a cantilevered mobile bed/chair apparatus comprised three hinged-together segments forming back, seat, and foot platforms operating in conjunction with a four-wheeled, rectangular base. The hinged-together platforms converted from a chair mode to a bed mode by a first jack located beneath the seat platform. The platforms were raised and lowered by a second jack associated with a telescoping tower attached to an E frame. The telescoping tower was mounted vertically from one side of the rectangular base, and when extended, had a height greater than a hospital bed. The E frame, which supported the platforms, was cantilevered horizontally from the top portion of the telescoping tower, and the height thereof was controlled by the second jack mounted together with the bottom portion of the telescoping tower, to the wheeled base.

In Blevins, when it was desired to transfer a patient from a hospital bed to the bed/chair apparatus, the unit was wheeled to the side of the hospital bed in the bed mode. The tower height was extended by the second jack, enabling the platforms to overhang in cantilever fashion the hospital bed by up to eighteen inches, and then lowered so as to press into the mattress of the hospital bed. Angled down edges of the platforms pressing into the mattress resulted in a tight embrace of the hospital bed, and an almost flat profile for the two beds so that a single caregiver could safely affect the patient transfer.

The apparatus of Blevins has proved effective in reducing the efforts of the health care giver in transferring patients from a hospital bed onto the bed/chair and vice versa, but it can be improved in a number of ways. For example, the apparatus of Blevins must be properly oriented with the appropriate platform for the patient's head positioned adjacent the patient's head. Otherwise, the apparatus must be backed away from the patient's bed, turned around 180°, and then returned to the patient's bed to continue the transfer.

Another shortcoming of the Blevins apparatus is that it cannot be positioned over a typical toilet for use by the patient. To provide this kind of service to a patient, the patient must be brought to the vicinity of the toilet, then lifted from the Blevins apparatus onto the toilet and then from the toilet back onto the Blevins apparatus.

Further, no means is provided by the Blevins apparatus to assist in lifting a patient from the floor onto the device. The present invention provides these and other advantages over the Blevins device.

### SUMMARY OF THE INVENTION

The present invention addresses these and other drawbacks in the prior art by providing a convertible bed or gurney and wheelchair that flexibly converts from one mode to the other mode with the patient's head at either end of the device.

A gurney/wheelchair of this invention is thus bi-directional. The device comprises five panels, including a center panel, a pair of intermediate panels, and a pair of end panels. The intermediate panels are interlocked so that they always remain parallel to one another. The end panels operate independently of one another. The device further includes a power means to raise and lower the center panel, which in turn raises and lowers the other panels. A pair of U-shaped support bars mechanically support a pair of parallel structural beams so that the device can be positioned over a standard toilet from either direction in respect of the device of this invention. Further, means is provided to mechanically assist a patient onto the gurney/wheelchair.

These and other features, objects, and advantages will be readily apparent to those of skill in the art from a review of the following detailed description along with the accompanying drawing figures.

### BRIEF DESCRIPTION OF THE DRAWINGS

So that the manner in which the above recited features, advantages, and objects of the present invention are obtained and can be understood in detail, more particular description of the invention, briefly summarized above, may be had by reference to the embodiments thereof which are illustrated in the appended drawings.

FIG. 1 is a side elevation view of a combination wheel chair/gurney of the present invention as seen from the point of view of an operator, such as for example a nurse or orderly.

FIG. 2 is a top view of the wheel chair/gurney of FIG. 1.

FIG. 3 is a side elevation view of the wheel chair/gurney, as seen from the opposite side, showing the device in various positions.

FIG. 4 is a cross-sectional view taken along section 4-4 as indicated in FIG. 1, showing details of a motor and a platform raising spindle.

FIG. 5 is a cross-sectional view taken along section 5-5 as indicated in FIG. 1, showing details of a bottom wheel-frame and connecting U-bars.

FIG. 6 is a cross-sectional view taken along section 6-6 as indicated in FIG. 5, showing the clearance provided by the U-shaped bars around a toilet commode.

FIG. 7 is a cross-sectional view as indicated in FIG. 8 showing hinge connections and linkage details.

FIG. 8 is a side view of FIG. 7 showing the connecting linkage of side panels.

FIG. 9 is the same as FIG. 8, except that the side panels are moved to an intermediate position, in order to illustrate function of linkage of the preferred embodiment.

FIG. 10 is the same as FIG. 8, except that side panels are moved to an extreme 90° position.

FIG. 11 is the same as FIG. 7, but with more detail of the connecting linkage.

FIG. 12 is a cross-sectional view as indicated in FIG. 11.

FIG. 13 is the same as FIG. 12, except that the side panels are rotated into an intermediate position and also in order to illustrate the function of a ratchet mechanism of this invention.

FIG. 14 is the same as FIG. 12, except that the side panels are rotated in the opposite direction.

FIG. 15 depicts an alternative connecting linkage with chains and sprockets.

FIG. 16 depicts an alternative connecting means with sheaves and cables.

FIG. 17 depicts an alternative simplified linkage.

FIG. 18 is an elevation view of the device of this invention in position, equipped with a padded sheet and winch, to pick up a fallen person off the floor.

FIG. 19 is a top view of FIG. 18.

FIG. 20 is a cross section of a winch.

FIG. 21 is an enlarged detail of FIG. 20.

FIG. 22 is a cross-section as indicated in FIG. 21.

FIG. 23 is a ratchet detail (like FIG. 21) in a disengaged position.

### DETAILED DESCRIPTION OF PREFERRED EMBODIMENTS

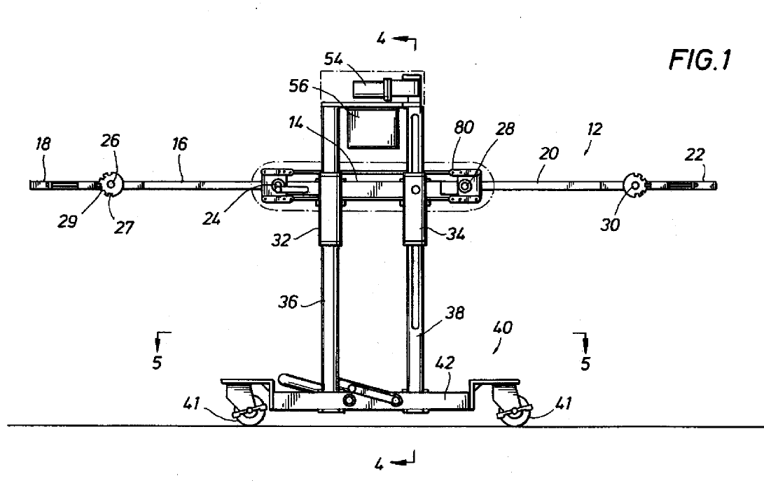

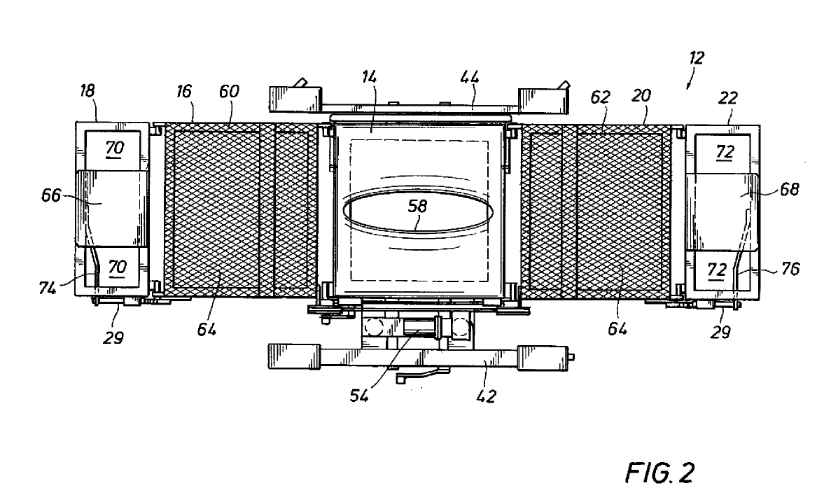

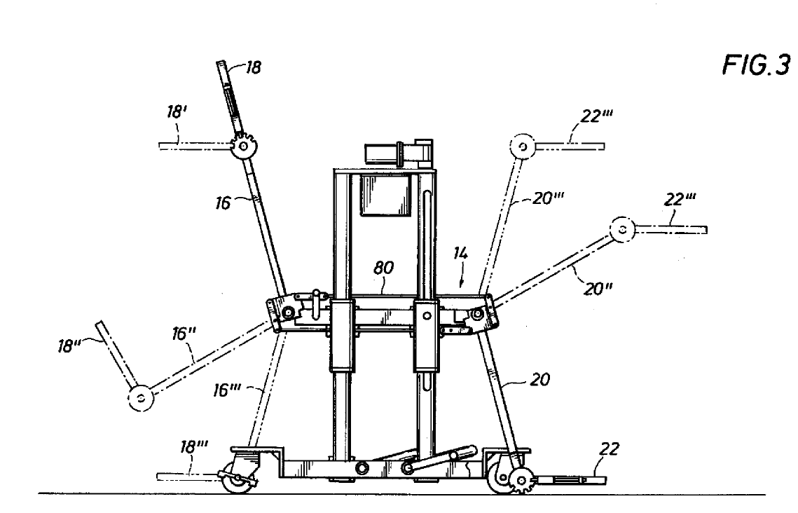

Referring to FIGS. 1 and 2, the present invention, in a first aspect, comprises a stretcher/wheelchair 12 to and from which a patient or handicapped person is transferred from a hospital or other type bed. The apparatus may support the patient for movement in a sitting or a prone position in the device. The device is bi-direction, meaning either end of the device may receive the head of the patient. Thus, the device may be wheeled to the side of the patient's hospital bed from either side, regardless of whether the patient's head is oriented to the right or the left. Once the patient has been placed into the device in its bed or gurney orientation, the device may be converted to a wheelchair, if desired. The patient may then be wheeled to a dinner table, to a shower, or even to a standard toilet, as described more fully below. Alternatively, the device serves as a typical wheeled bed or gurney, at the convenience of the healthcare provider.

The device, which defines a stretcher/wheelchair 12, comprises five panels, including a center panel 14, a pair of intermediate panels 16 and 20, and a pair of end panels 18 and 22. The panels are connected to adjacent panels by hinges 24, 26, 28, and 30, as illustrated. The hinge 26 connects the end panel 18 and the intermediate panel 16 and this hinge operates independently of the other hinges. The hinge 26 includes a plurality of grooves or holes adapted to receive a spring loaded plunger 29, so that the hinge 26 may be releasably secured in any of a variety of positions. Similarly, the hinge 30 connects the end panel 22 and the intermediate panel 22 and this hinge operates independently of the other hinges, and is preferably constructed in a manner previous described in respect of the hinge 26. The hinges 24 and 28, however, operate together with a linkage in a manner shown and described below.

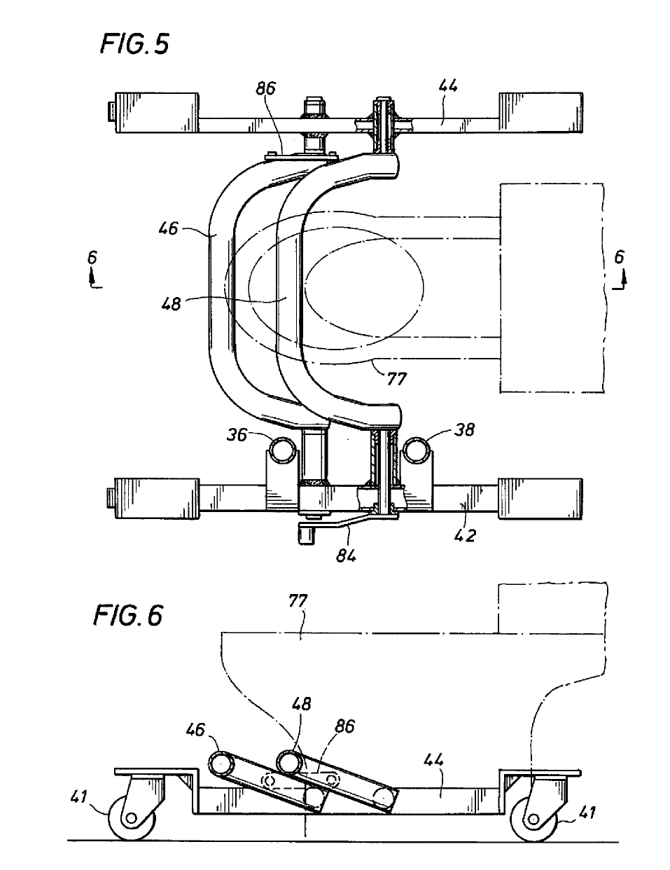

The center panel 14 is coupled to a complementary pair of parallel bearing sleeves 32 and 34, by which the entire stretcher 12 slides up or down along a pair of parallel stanchions 36 and 38. The stanchions 36 and 38 are supported at their lower ends by a wheeled base 40 having wheels 41, preferably four of such wheels. Preferably, the two wheels adjacent the operator or healthcare provider are provided with foot-operated brakes. The wheeled base 40 comprises a pair of parallel bars 42 and 44, which are joined together by two U-shaped bars 46 and 48, as shown best in FIG. 5 and described below in greater detail. The bars 46 and 48 can be swung from left to right, to permit the device 12 to be positioned over a standard toilet, whether the patient's head is positioned to the right or the left on the device 12.

The center panel 14 is built like a toilet seat, with an opening 58 in the center, so it can be used as a toilet seat or as an access opening to a patient's private parts when the patient is in the shower being scrubbed by a nurse. The intermediate panel 16 is formed of an outer metal frame 60 and a mesh covering 64, which allows water to be sprayed upon a patient's back, particularly in a shower. Similarly, the intermediate panel 20 is formed of an outer metal frame 62 with the mesh covering 64.

The end panels 18 and 22 alternately serve as a foot rest or as a handle to push the wheelchair, depending on whether the patient's head is positioned to the right or to the left. Panels 16 and 20 are always in a position parallel to one another due to a connecting linkage 80. The end panel 18 includes a central support plate 66 and access openings 70. Similarly, the end panel 22 includes a central support plate 68 and access openings 72. The access openings 70 and 72 provide access for a nurse's hands to operate a manual actuator 74 or 76 to operate the locking hinge 26 or the locking hinge 30 by manual manipulation of the spring loaded plunger 29.

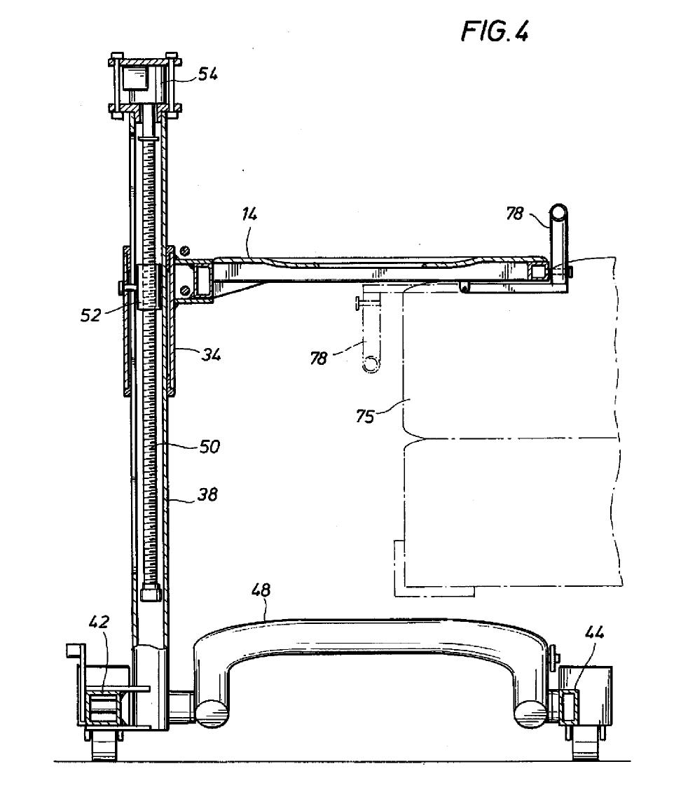

In operation of the present invention, with the patient lying in a hospital or similar bed, the device 12 is wheeled to the patient's bedside with the device oriented in a stretcher-like position as illustrated in FIGS. 1, 2, and 4. An adjustable handrail 78 is then released and pushed out of the way, as shown in phantom in FIG. 4. Once the device 12 is at the patient's bedside, the panels 14-22 are positioned over a mattress 75, and then lowered down onto the bed, as shown in FIG. 4. Now the patient can be rolled onto the stretcher in a manner most convenient to the healthcare provider. For example, if the patient is rolled ¼ turn away from the stretcher before the stretcher is positioned over the mattress, then the patient can be simply rolled carefully onto the stretcher. Or, the patient can be pulled onto the stretcher with a bed sheet until he is located in the middle of the stretcher, lying on his back.

It should be noted again that the device 12 is bi-directional, so that the patient's head may be located to right or to the left, depending on how he was lying in his hospital or similar bed, and the device can receive the patient in either direction. The patient does not have to be turned around in bed, or the device does not have to be turned around or carefully positioned from a particular side of the bed, which may not always be convenient or even possible.

Once the patient has been moved from his hospital bed onto the device 12, the stretcher can be raised to clear the bed. Once the device 12 is clear of the patient's bed, the patient can be transported with the device 12 remaining in a stretcher-like orientation, or the hinges can be operated to orient the device into a wheelchair-like orientation, as shown best in FIG. 3, which should now be referred to for the following detailed description.

If the patient's head is located to the left as seen in FIG. 3 and his feet are to the right, then panel 18 can be adjusted to a position that is parallel with the center panel 14. This places panel 18 in the position 18′, shown in phantom in FIG. 3. Similarly, the intermediate panel 16 is positioned as shown to serve as a backrest for the patient while panel 20 must remain parallel to panel 16 due to the interlocking linkage 80, shown and described below in greater detail. The end panel 22 is positioned as shown to serve as a footrest for the patient, and since the end panels operate independently of all of the other panels, the panel 22 may be positioned for the comfort and convenience of the patient.

Conversely, if the patient's head is positioned to the right as seen in FIG. 3, then the panel 20 may be positioned as shown in phantom as position 20″ or position 20′″. The panel 16 is interlocked with panel 20, and will assume position 16″ or 16′″, respectively. The panel 18 may then be placed in position 18″ or 18′″ as a footrest, for the convenience and comfort of the patient.

Furthermore, the panels 16-22 of the chair can be left in an intermediate position, as shown in FIG. 3 by panels 16″, 18″, 20″, and 22″. This position may be enjoyed by a patient to simply sit and relax, or read, or enjoy the sun in a solarium, for example.

Referring once again to FIG. 4, a section view of the device 12 taken along section lines 4-4 of FIG. 1 is depicted. This detail view of the invention illustrates the power operation of the apparatus to raise and lower the panels. Inside stanchion 38 is a spindle 50, on which rides a nut 52, which is mechanically coupled to the center panel 14. The nut 52 rides up and down along the spindle when the spindle 50 is rotated by a battery driven motor 54 clockwise or counter clockwise. Power is fed to the motor 54 from a battery 56, shown in FIG. 1. The battery is preferably rechargeable, and resides in a sealed case so that the device may safely be used in the shower with a patient sitting therein.

FIGS. 4, 5, and 6 together illustrate another feature of the present invention. If a patient needs to be moved to a toilet, the wheelchair device 12 can be lowered until the footrest (either 18 or 22) almost touches the floor, then the chair can be backed over the toilet, as shown in FIGS. 5 and 6. However, in order to do so, the structural supports which join the pair of parallel bars 42 and 44 must permit the movement of the device either to the right or the left in order to retain the previously described bi-directional feature of this invention. This is accomplished by joining the parallel bars 42 and 44 by a pair of U-shaped bars 46 and 48, which are rotatably mounted to the bars 42 and 44. If the U-shaped bars 46 and 48 are in the way of the toilet, they can be swung to the other side.

There are two of these bars connecting the two side bars 42 and 44 to keep the bars 42 and 44 parallel and to provide greater rigidity and stability to the device 12. So that the two U-shaped bars move together simultaneously with a hand crank 84, they are connected by a bar 86 (FIGS. 5 and 6). In fact, the hand crank 84 may be omitted, and the U-shaped bars can be moved as a unit simply by moving one of them.

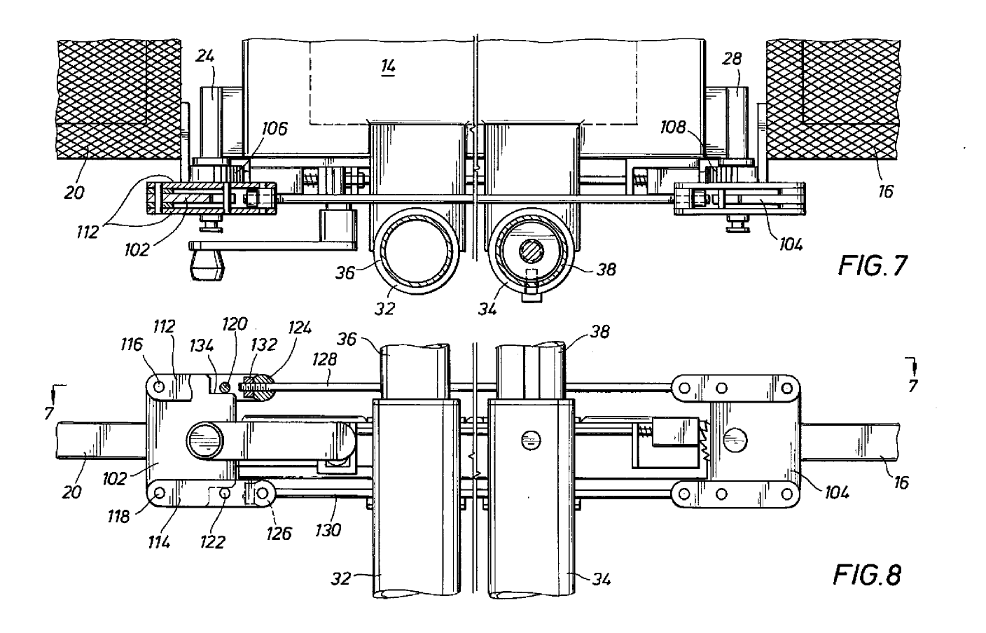

As previously described, one of the features of the invention resides in the fact that the intermediate panels 16 and 20 are interlocked together so that they always remain parallel to one another. This feature is shown and described in greater detail in FIGS. 7, 8, 9, and 10. These figures illustrate the mechanism that holds the two side panels 16 and 20 parallel.

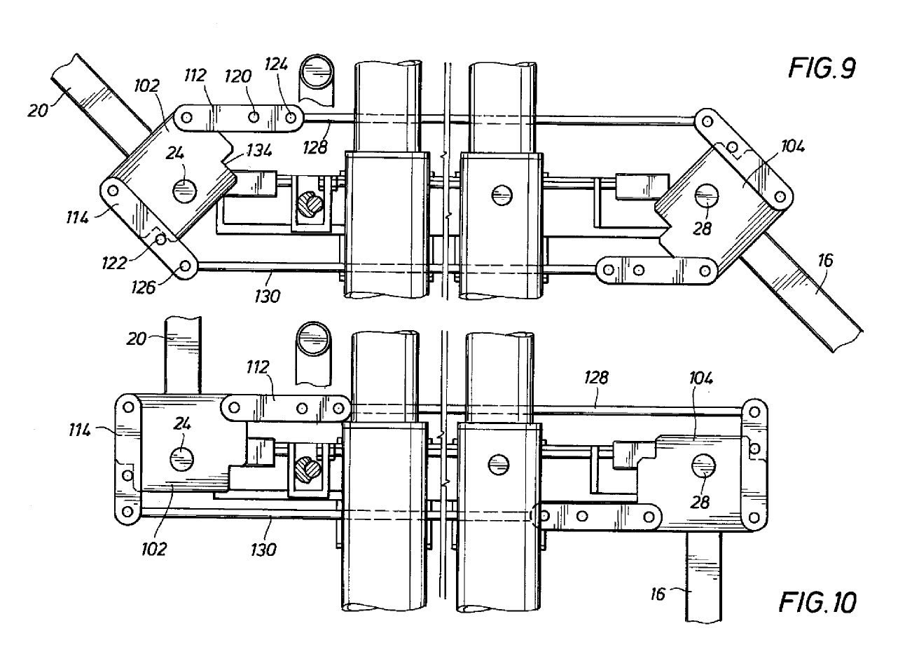

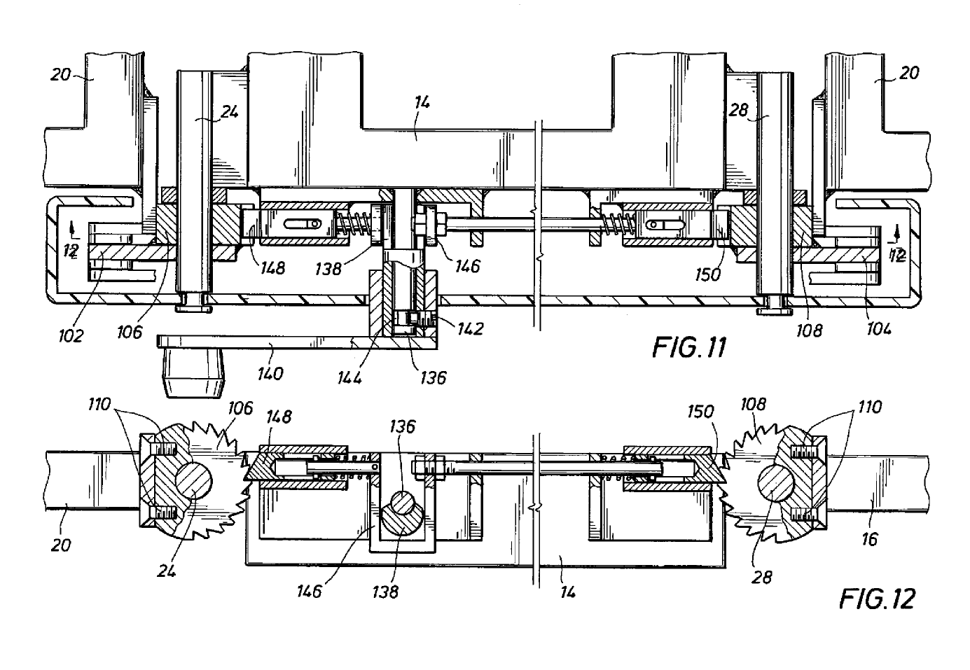

Referring first to FIGS. 7 and 8, the hinges 24 and 28 (see also FIG. 1) are mechanically coupled to the central panel 14. A pair of plates 102 and 104 ride on the hinges 24 and 28. To the back of theses plates are welded a set of ratchet wheels 106 and 108, and the panels 16 and 20 are bolted to these ratchet wheels with bolts 110 (See FIG. 12). Two pairs of linkages 112 and 114 are attached to the plate 102 by a pivot pin 116 and a pivot pin 118. Pins 120 and 122 rest against a step 134 in plate 102 so the linkage pairs can never swing “inward”, only outwardly as illustrated in FIG. 9. The inward ends of the linkage pairs hold swivel pins 124 and 126 which are connected by rods 128 and 130 to the identical linkage on the plate 104. Thus, the panels 16 and 20 are always in a parallel position. Nuts 132 on the ends of the rods 128 and 130 can be used to adjust the length of the rods, which determines the exact degree of parallel of the two panels 16 and 20, which is particularly important for the straight position of the five panels of the stretcher part 12 when lowered onto the edge of a patients bed. This feature is illustrated in FIGS. 9 and 10, wherein in FIG. 9 the panels 16 and 20 as positioned at an acute angle to the horizontal, but parallel to one another, and in FIG. 10, the panels 16 and 20 are positioned at a vertical.

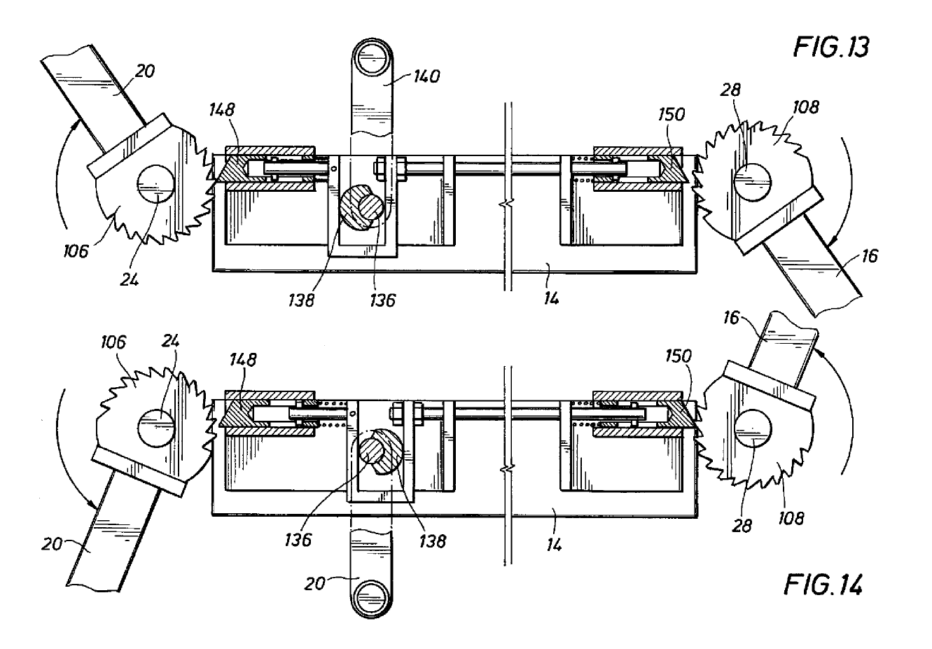

FIGS. 11 and 12 show the locking mechanism which locks panels 16 and 20 into a desired position. Attached to frame 14 is a pin 136 on which rotates a cam 138. To rotate the cam, a crank 140 is mounted onto it via set screw 142, which also engages a groove 144 in pin 136 to prevent the crank 140 and cam 138 from slipping off the pin 136. The cam 138 is situated inside a yoke 146. When the cam 138 is turned 90° clockwise, as shown in FIG. 13, the yoke 146 is pushed to the left as viewed in FIG. 11, which increases spring pressure against a tooth 148 and into engagement with the ratchet 106, while tooth 150 is pulled out of ratchet wheel 108 to let it rotate freely in the same direction as 106 (in this case clockwise), because the two ratchet wheels are still connected via linkage rods 128 and 130. In this case, panel 20 on the left goes up, while panel 16 on the right goes down by the same degree. This entire process can, of course, be reversed by rotating crank 140 and cam 138 counter-clockwise, as shown in FIG. 14.

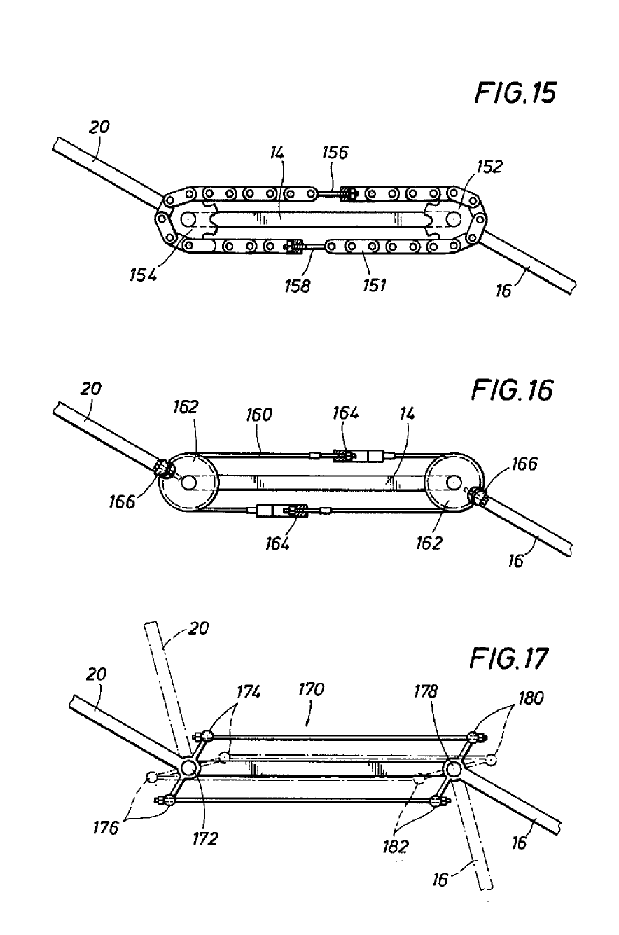

FIG. 15 shows an alternative connection between side panels 16 and 20, which is a bicycle chain 151 and sprockets 152 and 154. This structure maintains the panels 16 and 20 in a parallel relationship, but with an alternative arrangement to that previously described. Bolt connections 156 and 158 are necessary to adjust chain tension and precise position of sprockets and side panels. Since the device 12 is intended to be used in a wet environment, such as a shower, all parts must be stainless steel. In this case, stainless steel bicycle chain and sprockets are rather expensive, and therefore less preferred.

FIG. 16 illustrates another preferred embodiment, showing cables 160 and sheaves 162 instead of chains and sprockets. Here, as in previous embodiments, tensioning devices 164 must be employed and in addition anti-friction devices 166 to prevent the cables from slipping.

A simplified linkage 170 could be used, as shown in FIG. 17. However, this linkage can only be practical for rotating motions of less than 90°, because at 90°, points 172, 174 and 176 would be in a straight line with points 178, 180 and 182. That, for obvious reasons, would no longer work to hold the two side panels 16 and 20 parallel. The linkage 170 shown in dotted lines approaches that position to be able to rotate the side panels 90° or even a little more, thus the linkage shown in FIGS. 8-10 is preferred.

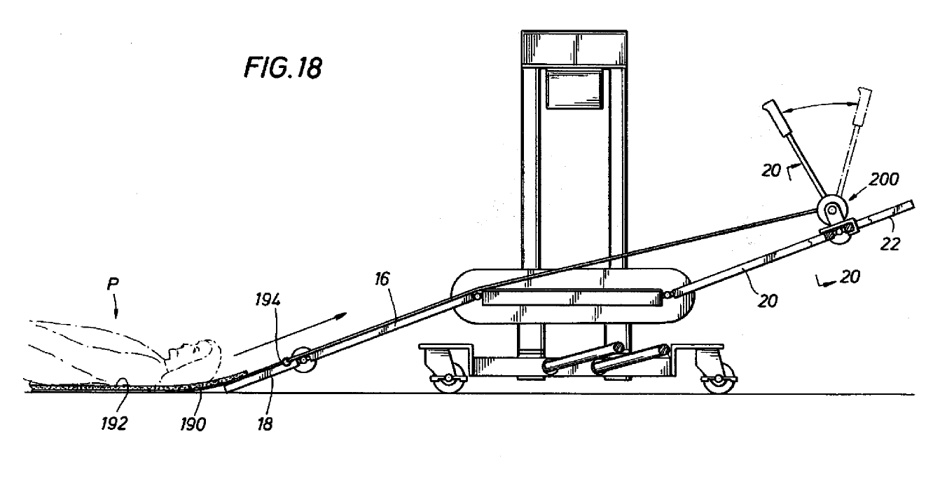

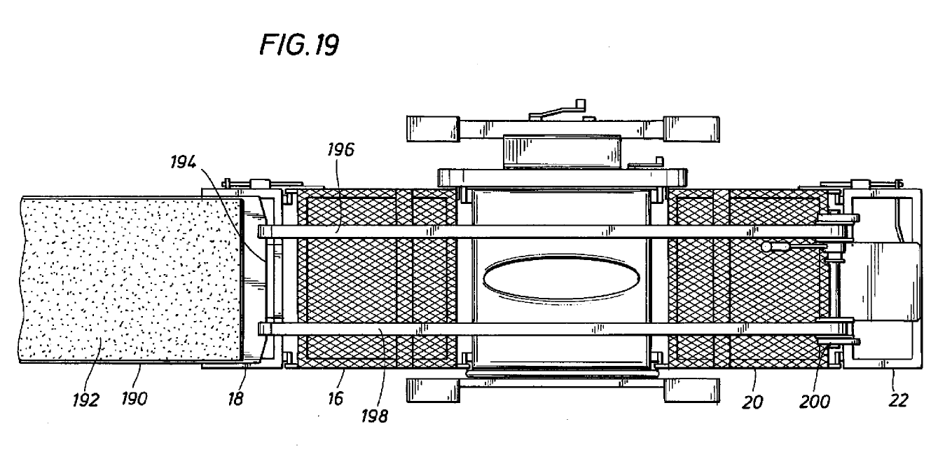

As shown in FIGS. 18 and 19, in another aspect of the invention, a patient that has fallen to the floor may be brought onto the device with mechanical assistance from the device, without much effort by nursing personnel. This feature of the present invention reduces the likelihood of back injuries to nurses or other healthcare professionals trying to handle immobilized patients.

As illustrated in FIGS. 18 and 19, the center panel 14 of the device 12 is first put in its lowest possible position, with panel 16 and panel 18 in a straight line. The hinge 24 is then tilted until the panel 18 touches the floor, while panel 20 rises by the same amount. A person P, who has fallen to the floor, is then rolled or pulled onto a sheet of nylon 190, which is padded on top with a layer of foam rubber 192. The upper end 194 of the sheet is attached to belts 196 and 198, which in turn are attached to a winch 200, which is hooked to a frame member of panel 22. When the winch is operated, belts 196 and 198 are reeled into it and pull sheet 190 with the person P on top up onto the platform of the chair, from where the person can be raised and put into a normal position, without any strain or possible back injury to the healthcare professional assisting the patient.

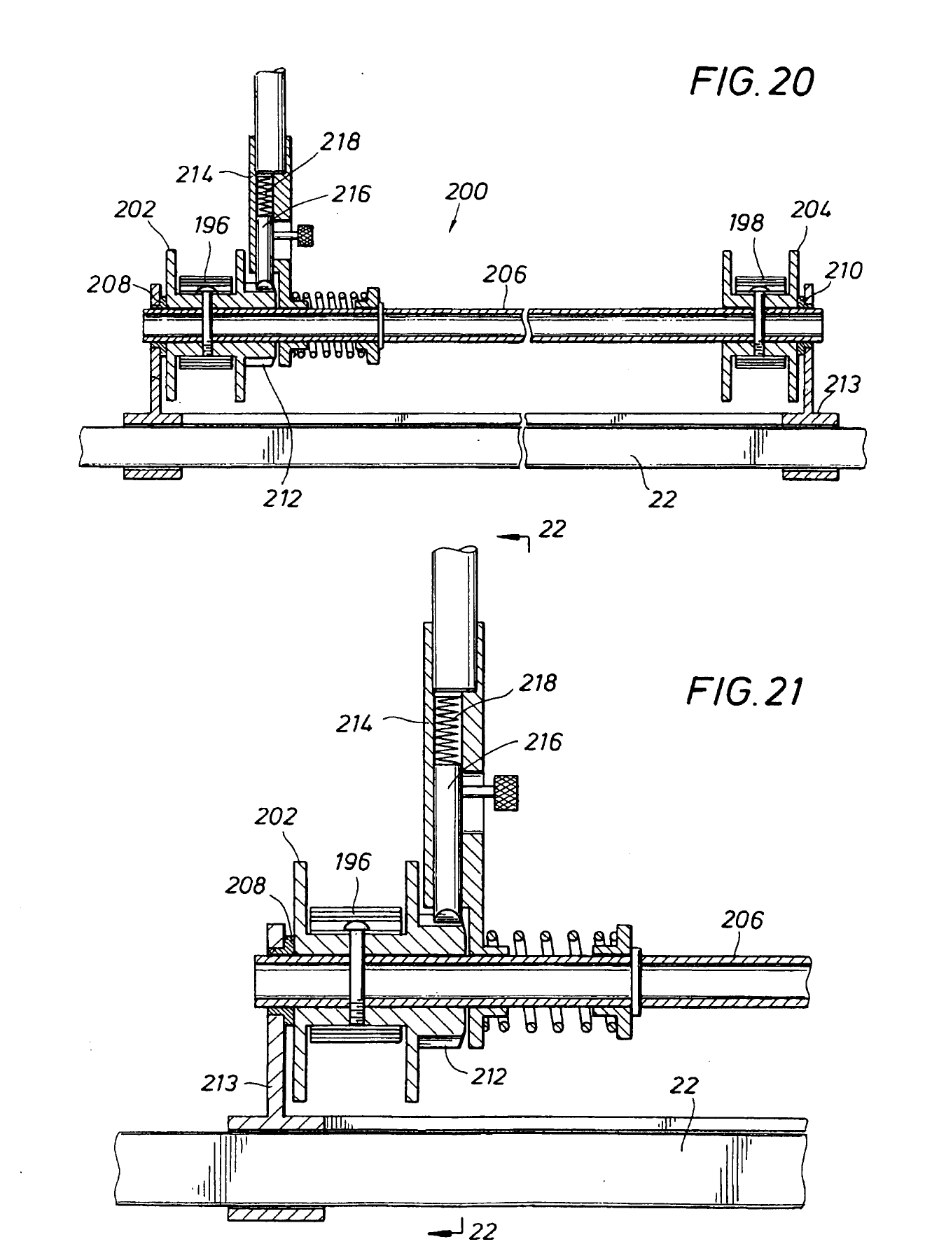

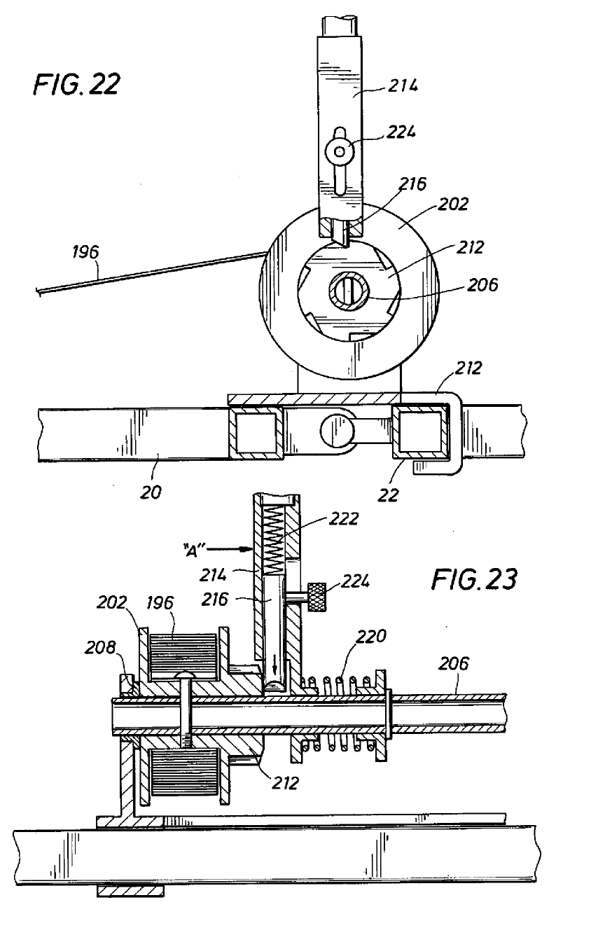

FIGS. 20 to 23 are details of the winch 200, which consists of two spools 202 and 204, which are both mounted on a common shaft 206. The shaft 206 is able to rotate in bearings 208 and 210, which are held in base structure 213. The spool 202 is equipped with a ratchet wheel 212. A lever 214 carries a ratchet tooth 216, which is pushed into contact with ratchet wheel 212 by a spring 218. As can best be seen in FIG. 22, the ratchet wheel 212 together with spool 202 rotates when lever 214 is moved back and forth; and spool 204 rotates with it, since it too is connected to common shaft 206. An operator rests his other hand on spool 204 to keep both spools from rotating backwards, while tooth 216 is being rotated into the next notch of ratchet wheel 212.

To pull sheet 190 down and un-spool belts 196 and 198 from the winch, the ratchet can be put into a disengaged position, as shown in FIG. 23. By exerting pressure “A” against lever, it will move against spring 220, thereby allowing spring 222 to push ratchet tooth 216 down alongside ratchet wheel 212. Now spools 202 and 204 are free to rotate, when belts 196 and 198 are un-spooled.

To re-engage tooth and ratchet, tooth 216 is pulled up via pin handle 224 against spring 222, spring 220 can expand and push lever 214 back over ratchet wheel 212.

Those of skill in this art will appreciate that certain protective covers may be provided throughout the device 12 to protect patients and healthcare providers and to provide a more esthetic appearance to the device, without detracting from the structure and/or function of this invention.

The principles, preferred embodiments, and modes of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

What is claimed is:

1. A device for transporting a patient comprising:
a. a center panel;
b. a pair of intermediate panels joined with a first set of hinges to the center panel opposite one another;
c. a pair of end panels joined with a second set of hinges to the intermediate panels opposite one another; and
d. an interlock joining the intermediate panels to maintain the intermediate panels parallel to one another.

2. The device of claim 1, wherein the second set of hinges operate independently of one another.

3. The device of claim 1, further comprising means to raise and lower the center panel in a vertical direction.

4. The device of claim 3, wherein the means to raise and lower the center panel comprises:
a. a pair of bearing sleeves secured to the center panel;
b. a pair of vertical stanchions slidably engaged within the bearing sleeves; and
c. a power mechanism to move the sleeves and the stanchions relative to one another.

5. The device of claim 4, further comprising a wheeled base supporting the stanchions.

6. The device of claim 5, further comprising wherein the base includes a pair of parallel bars, and further comprising a pair of U-shaped support bars rotatably mounted to the parallel bars.

7. The device of claim 6, further comprising a coupling joining the U-shaped support bars for simultaneous movement.

8. The device of claim 1, wherein the center panel includes a toilet access hole therethrough.

9. The device of claim 1, further comprising means to mechanically assist in bringing a patient onto the device.

10. The device of claim 9, wherein the means to mechanically assist in bringing a patient onto the device comprises:
a winch;
a pallet; and
a strap joining the pallet and the winch.

11. A device for transporting a patient comprising:
a. a center panel;
b. a pair of intermediate panels joined with a first set of hinges to the center panel opposite one another;
c. a pair of end panels joined with a second set of hinges to the intermediate panels opposite one another; and
d. a wheeled base supporting the panels, the wheeled base comprising a pair of spaced apart wheeled bars held apart by a pair of U-shaped support bars.

12. The device of claim 11, wherein the U-shaped support bars are rotatably mounted to the wheeled bars.

13. The device of claim 11, further comprising an interlock joining the intermediate panels to maintain the intermediate panels parallel to one another.

14. The device of claim 11, further comprising means to raise and lower the center panel in a vertical direction, the means to raise and lower comprising:
a. a pair of bearing sleeves secured to the center panel;
b. a pair of vertical stanchions slidably engaged within the bearing sleeves; and
c. a power mechanism to move the sleeves and the stanchions relative to one another.

15. The device of claim 11, wherein the center panel includes a toilet access hole therethrough.

16. A device for transporting a patient comprising:
a center panel;
a pair of intermediate panels joined with a first set of hinges to the center panel opposite one another;
a pair of end panels joined with a second set of hinges to the intermediate panels opposite one another; and
means to mechanically assist in bringing a patient onto the device.

17. The device of claim 16, wherein the means to mechanically assist in bringing a patient onto the device comprises:
a. a winch;
b. a pallet; and
c. a strap joining the pallet and the winch.

18. The device of claim 16, further comprising means to raise and lower the center panel in a vertical direction, the means to raise and lower comprising:
a pair of bearing sleeves secured to the center panel;
a pair of vertical stanchions slidably engaged within the bearing sleeves; and
a power mechanism to move the sleeves and the stanchions relative to one another.

19. The device of claim 16, further comprising a wheeled base supporting the stanchions.

20. The device of claim 19, wherein the base includes a pair of parallel bars, and further comprising a pair of U-shaped support bars rotatably mounted to the parallel bars.
